(19) United States
(12) Patent Application Publication
(10) Pub. No.: US 2017/0285932 A1
(43) Pub. Date: Oct. 5, 2017

(54) Ink Input for Browser Navigation

(71) Applicant: Microsoft Technology Licensing, LLC, Redmond, WA (US)

(72) Inventors: Ryan Lucas Hastings, Seattle, WA (US); Daniel McCulloch, Snohomish, WA (US); Michael John Patten, Sammamish, WA (US)

(73) Assignee: Microsoft Technology Licensing, LLC, Redmond, WA (US)

(21) Appl. No.: 15/197,287

(22) Filed: Jun. 29, 2016

Related U.S. Application Data
(60) Provisional application No. 62/314,592, filed on Mar. 29, 2016.

(51) Int. Cl. G06F 3/0488; G06F 17/21; G06F 17/30; G06F 17/27; G06F 3/0482; G06F 3/0354; G06K 9/00

(52) U.S. Cl. CPC G06F 3/04883; G06F 3/03545; G06F 17/214; G06K 9/00422; G06F 17/276; G06F 17/2765; G06F 3/0482; G06F 17/30873

(57) ABSTRACT

Techniques for ink input for browser navigation are described. Generally, ink refers to freehand input to a touch-sensing functionality and/or a functionality for sensing touchless gestures, which is interpreted as digital ink. According to various embodiments, ink input for browser navigation provides a seamless integration of an ink input canvas with a web browser graphical user interface (“GUI”) to enable intuitive input of network addresses (e.g., web addresses) via ink input.

### PRIORITY

This application claims priority to U.S. Provisional Application Serial No. 62/314,592 entitled “Ink Input for Browser Navigation” and filed Mar. 29, 2016, the disclosure of which is incorporated by reference herein in its entirety.

### BACKGROUND

Devices today (e.g., computing devices) typically support a variety of different input techniques. For instance, a particular device may receive input from a user via a keyboard, a mouse, voice input, touch input (e.g., to a touchscreen), and so forth. One particularly intuitive input technique enables a user to utilize a touch instrument (e.g., a pen, a stylus, a finger, and so forth) to provide freehand input to a touch-sensing functionality such as a touchscreen, which is interpreted as digital ink. The freehand input may be converted to a corresponding visual representation on a display, such as for taking notes, for creating and editing an electronic document, and so forth. Many current techniques for digital ink, however, typically provide limited ink functionality.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for ink input for browser navigation are described. Generally, ink refers to freehand input to a touch-sensing functionality and/or a functionality for sensing touchless gestures, which is interpreted as digital ink. According to various embodiments, ink input for browser navigation provides a seamless integration of an ink input canvas with a web browser graphical user interface (“GUI”) to enable intuitive input of network addresses (e.g., web addresses) via ink input.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein in accordance with one or more embodiments.

FIG. 2 depicts an example implementation scenario for presenting an ink canvas in a web browser in accordance with one or more embodiments.

FIG. 3 depicts an example implementation scenario for receiving input to an ink canvas in a web browser in accordance with one or more embodiments.

FIG. 4 depicts an example implementation scenario for providing completion suggestions in accordance with one or more embodiments.

FIG. 5 depicts an example implementation scenario for providing an ink suggestion in accordance with one or more embodiments.

FIG. 6 depicts an example implementation scenario for navigating to a website based on an address input via ink input in accordance with one or more embodiments.

FIG. 7 is a flow diagram that describes steps in a method for presenting an ink canvas for a web browser in accordance with one or more embodiments.

FIG. 8 is a flow diagram that describes steps in a method for presenting an ink suggestion based on character input in accordance with one or more embodiments.

FIG. 9 is a flow diagram that describes steps in a method for presenting a completion suggestion based on character input in accordance with one or more embodiments.

FIG. 10 is a flow diagram that describes steps in a method for formatting characters for an ink suggestion in accordance with one or more embodiments.

FIG. 11 illustrates an example system and computing device as described with reference to FIG. 1, which are configured to implement embodiments of techniques described herein.

### DETAILED DESCRIPTION

Overview

Techniques for ink input for browser navigation are described. Generally, ink refers to freehand input to a touch-sensing functionality and/or a functionality for sensing touchless gestures, which is interpreted as digital ink, referred to herein as “ink.” Ink may be provided in various ways, such as using a pen (e.g., an active pen, a passive pen, and so forth), a stylus, a finger, touchless gesture input, and so forth.

According to various implementations, ink input for browser navigation provides a seamless integration of an ink input canvas with a web browser graphical user interface (“GUI”) to enable intuitive input of network addresses (e.g., web addresses) via ink input.

For instance, in an example scenario, a web browser GUI is displayed on a client device. The browser GUI includes an address region (e.g., an address bar) in which addresses for websites and other network locations can be entered to cause navigation of the web browser to a corresponding network location. According to techniques described herein, a user places a digital pen (hereinafter “pen”) or other input device in proximity to the address bar. The user, for instance, taps the pen within or adjacent the address bar.

Accordingly, in response to detecting the pen, an ink canvas is displayed that replaces or overlays the address bar. Generally, the ink canvas represents a visually distinct region within the browser GUI that is configured to receive freehand input, such as via a pen. In this particular scenario, the user writes with the pen within the ink canvas, which causes ink input to be applied within the ink canvas. Text recognition is performed on the ink input to generate output characters, such as known alphabetic or numeric characters. The output characters can be used to generate a network address for a network location, such as a website. The web browser then navigates to the network location using the network address.

According to various implementations, when characters are recognized from ink input, completion suggestions are presented that include the characters and that correspond to known network addresses. The completion suggestions, for instance, include the characters recognized from ink input as well as additional characters to form complete network addresses. The completion suggestions may be identified in various ways, such as based on browsing history of a user, popular websites, trending web searches, and so forth. The completion suggestions may be presented within a browser GUI such that a user can select a particular suggestion to cause browser navigation to a corresponding network location. Further, a position of the completion suggestions within a browser GUI may be determined in various ways, such as to avoid obscuring the completion suggestions with an input device and/or a user's hand that is providing ink input.

According to various implementations, ink input to an ink canvas can be appended with an ink suggestion that corresponds to a particular network location. For instance, when a user begins entering ink input into an ink canvas and characters are recognized from the ink canvas, a set of additional characters are automatically generated and appended to the ink input to form an ink suggestion that corresponds to a complete network address. The additional characters may be visually distinguished from the ink input, such as by shading and/or coloring the additional characters differently than the ink input. Accordingly, a user may interact with the ink suggestion to select the ink suggestion and cause a web browser to navigate to a corresponding network location.

Thus, techniques described herein provide a tight coupling between a web browser and freehand input of network addresses to the web browser. For instance, ink input functionality may be integrated into a web browser such that an external ink recognition service need not be launched to enable ink input to the web browser. This reduces computing resources required to enable ink input to a web browser as compared to previous solutions that utilize external input sources that require ink input to be converted and then exported to a web browser. Further, a user need not divert their focus from a web browser to provide ink input to the web browser, thus enabling more accurate input of network addresses via freehand input.

In the following discussion, an example environment is first described that is operable to employ techniques described herein. Next, a section entitled “Example Implementation Scenarios” describes some example implementation scenarios in accordance with one or more embodiments. Following this, a section entitled “Example Procedures” describes some example procedures in accordance with one or more embodiments. Finally, a section entitled “Example System and Device” describes an example system and device that are operable to employ techniques discussed herein in accordance with one or more embodiments.

Having presented an overview of example implementations in accordance with one or more embodiments, consider now an example environment in which example implementations may by employed.

Example Environment

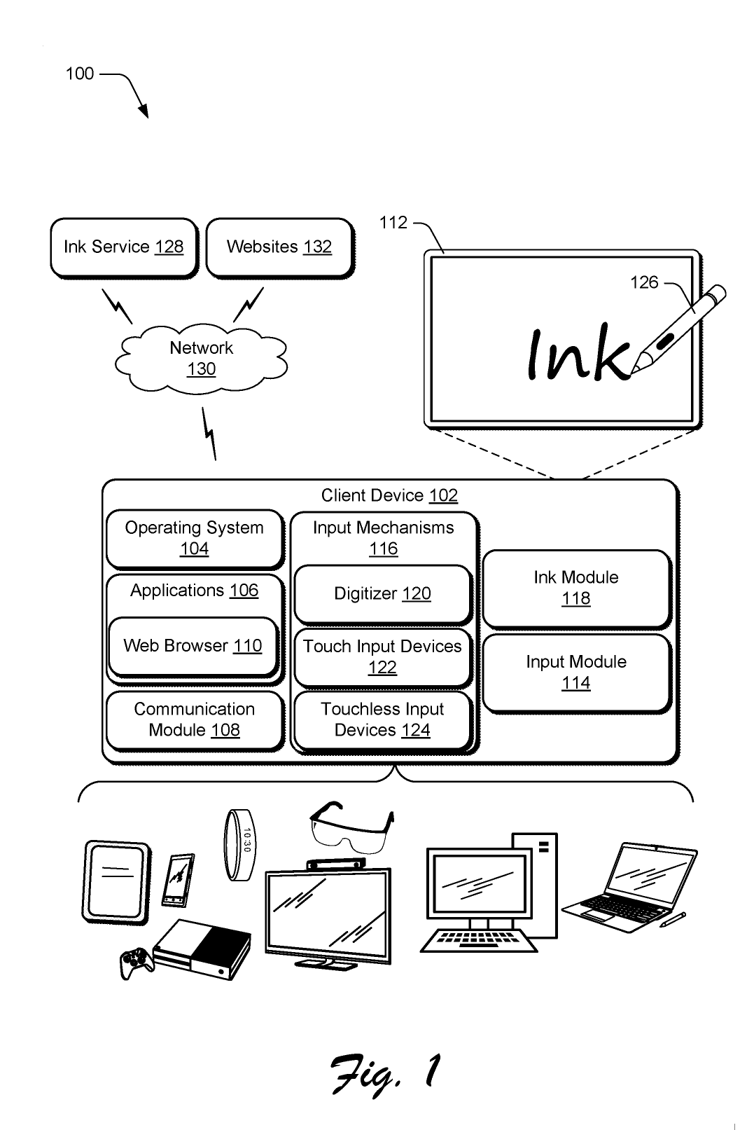

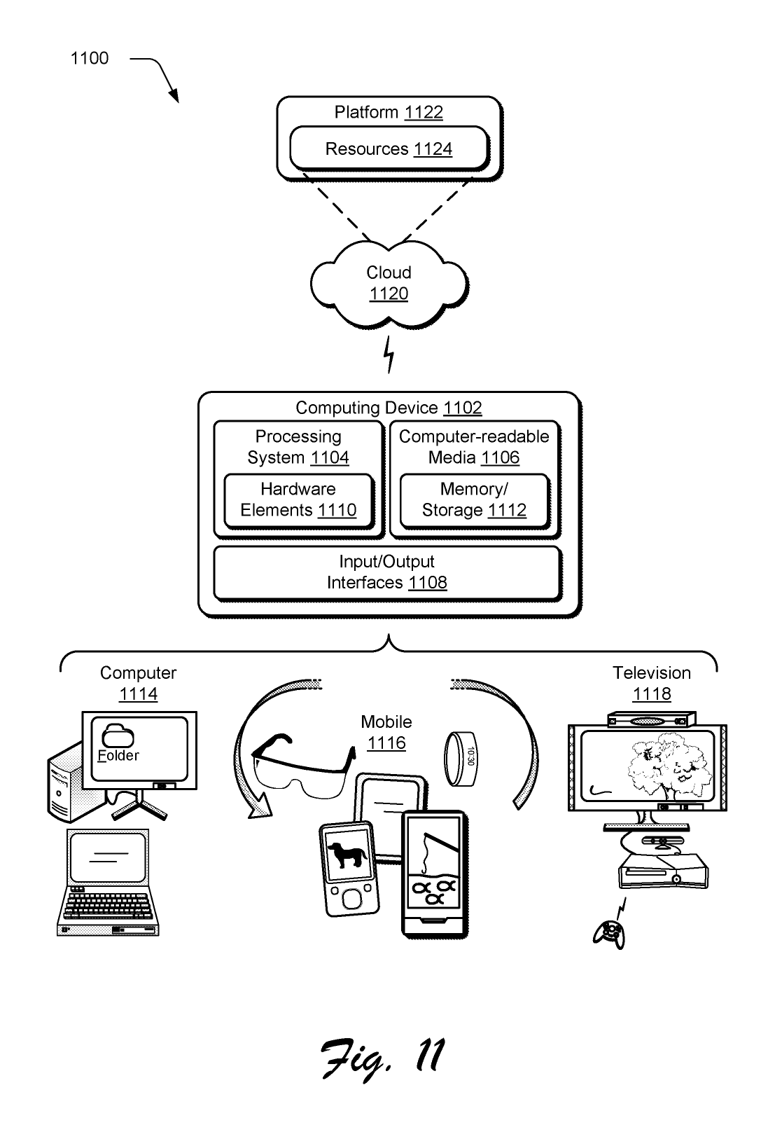

FIG. 1 is an illustration of an environment 100 in an example implementation that is operable to employ techniques for ink input for browser navigation discussed herein. Environment 100 includes a client device 102 which can be embodied as any suitable device such as, by way of example and not limitation, a smartphone, a tablet computer, a portable computer (e.g., a laptop), a desktop computer, a wearable device, and so forth. In at least some implementations, the client device 102 represents a smart appliance, such as an Internet of Things (“IoT”) device. Thus, the client device 102 may range from a system with significant processing power, to a lightweight device with minimal processing power. One of a variety of different examples of a client device 102 is shown and described below in FIG. 11.

The client device 102 includes a variety of different functionalities that enable various activities and tasks to be performed. For instance, the client device 102 includes an operating system 104, applications 106, and a communication module 108. Generally, the operating system 104 is representative of functionality for abstracting various system components of the client device 102, such as hardware, kernel-level modules and services, and so forth. The operating system 104, for instance, can abstract various components (e.g., hardware, software, and firmware) of the client device 102 to the applications 106 to enable interaction between the components and the applications 106.

The applications 106 represents functionalities for performing different tasks via the client device 102. Examples of the applications 106 include a word processing application, a spreadsheet application, a web browser 110, a gaming application, and so forth. The applications 106 may be installed locally on the client device 102 to be executed via a local runtime environment, and/or may represent portals to remote functionality, such as cloud-based services, web apps, and so forth. Thus, the applications 106 may take a variety of forms, such as locally-executed code, portals to remotely hosted services, and so forth.

The communication module 108 is representative of functionality for enabling the client device 102 to communication over wired and/or wireless connections. For instance, the communication module 108 represents hardware and logic for communicating data via a variety of different wired and/or wireless technologies and protocols.

The client device 102 further includes a display device 112, an input module 114, input mechanisms 116, and an ink module 118. The display device 112 generally represents functionality for visual output for the client device 102. Additionally, the display device 112 represents functionality for receiving various types of input, such as touch input, pen input, touchless proximity input, and so forth. The input module 114 is representative of functionality to enable the client device 102 to receive input (e.g., via the input mechanisms 116) and to process and route the input in various ways.

The input mechanisms 116 generally represent different functionalities for receiving input to the client device 102, and include a digitizer 120, touch input devices 122, and touchless input devices 124. Examples of the input mechanisms 116 include gesture-sensitive sensors and devices (e.g., such as touch-based sensors and movement-tracking sensors (e.g., camera-based)), a mouse, a keyboard, a stylus, a touch pad, accelerometers, a microphone with accompanying voice recognition software, and so forth. The input mechanisms 116 may be separate or integral with the display device 112; integral examples include gesture-sensitive displays with integrated touch-sensitive and/or motion-sensitive sensors. The digitizer 120 represents functionality for converting various types of input to the display device 112 and the touch input devices 122 into digital data that can be used by the client device 102 in various ways, such as for generating digital ink.

The touchless input devices 124 generally represent different devices for recognizing different types of non-contact input, and are configured to receive a variety of touchless input, such as via visual recognition of human gestures, object scanning, voice recognition, color recognition, and so on. In at least some embodiments, the touchless input devices 124 are configured to recognize gestures, poses, body movements, objects, images, and so on, via cameras. The touchless input devices 124, for instance, include a camera that is configured with lenses, light sources, and/or light sensors such that a variety of different phenomena can be observed and captured as input. For instance, the camera can be configured to sense movement in a variety of dimensions, such as vertical movement, horizontal movement, and forward and backward movement, e.g., relative to the touchless input devices 124. Thus, in at least some embodiments, the touchless input devices 124 can capture information about image composition, movement, and/or position. The input module 114 can utilize this information to perform a variety of different tasks, such as for providing input to various functionalities of the client device 102, including the applications 106.

For example, the input module 114 can leverage the touchless input devices 124 to perform skeletal mapping along with feature extraction with respect to particular points of a human body (e.g., different skeletal points) to track one or more users (e.g., four users simultaneously) to perform motion analysis. In at least some embodiments, feature extraction refers to the representation of the human body as a set of features that can be tracked to generate input.

According to various implementations, the ink module 118 represents functionality for performing various aspects of techniques for ink input for browser navigation discussed herein. The ink module 118, for instance, represents ink functionality that can be integrated into the web browser 110, such as to enable seamless integration of ink input to the web browser 110. Various functionalities of the ink module 118 are discussed below.

The environment 100 further includes a pen 126, which is representative of an input device for providing input to the display device 112. Generally, the pen 126 is in a form factor of a traditional pen but includes functionality for interacting with the display device 112 and other functionality of the client device 102. In at least some implementations, the pen 126 is an active pen that includes electronic components for interacting with the client device 102. The pen 126, for instance, includes a battery that can provide power to internal components of the pen 126.

Alternatively or additionally, the pen 126 may include a magnet or other functionality that supports hover detection over the display device 112. This is not intended to be limiting, however, and in at least some implementations the pen 126 may be passive, e.g., a stylus without internal electronics. Generally, the pen 126 is representative of an input device that can provide input that can be differentiated from other types of input by the client device 102. For instance, the digitizer 120 is configured to differentiate between input provided via the pen 126, and input provided by a different input mechanism such as a user's finger, a stylus, and so forth.

The environment 100 further includes an ink service 128 with which the client device 102 may communicate, e.g., via a network 130. Generally, the ink service 128 may be leveraged to perform various aspects of ink input for browser navigation described herein. In at least some implementations, the ink service 128 represents a network-based service (e.g., a cloud service) that can perform various functionalities discussed herein.

The network 130 may be implemented in various ways, such as a wired network, a wireless network, and combinations thereof. In at least some implementations, the network 130 represents the Internet. For instance, the web browser 110 may be leveraged to browse websites 132 that are accessible via the network 130. The web browser 110, for example, represents functionality for retrieving, presenting, and traversing information resources (e.g., the websites 132) that are available via the network 130.

Having described an example environment in which the techniques described herein may operate, consider now a discussion of some example implementation scenarios in accordance with one or more embodiments.

Example Implementation Scenarios

This section describes some example implementation scenarios for ink input for browser navigation in accordance with one or more implementations. The implementation scenarios may be implemented in the environment 100 described above, the system 1100 of FIG. 11, and/or any other suitable environment. The implementation scenarios and procedures, for example, describe example operations of the client device 102, the ink module 118, and/or the ink service 128. While the implementation scenarios and procedures are discussed with reference to a particular application, it is to be appreciated that techniques for ink input for browser navigation discussed herein are applicable across a variety of different applications, services, and environments. In at least some embodiments, steps described for the various procedures are implemented automatically and independent of user interaction.

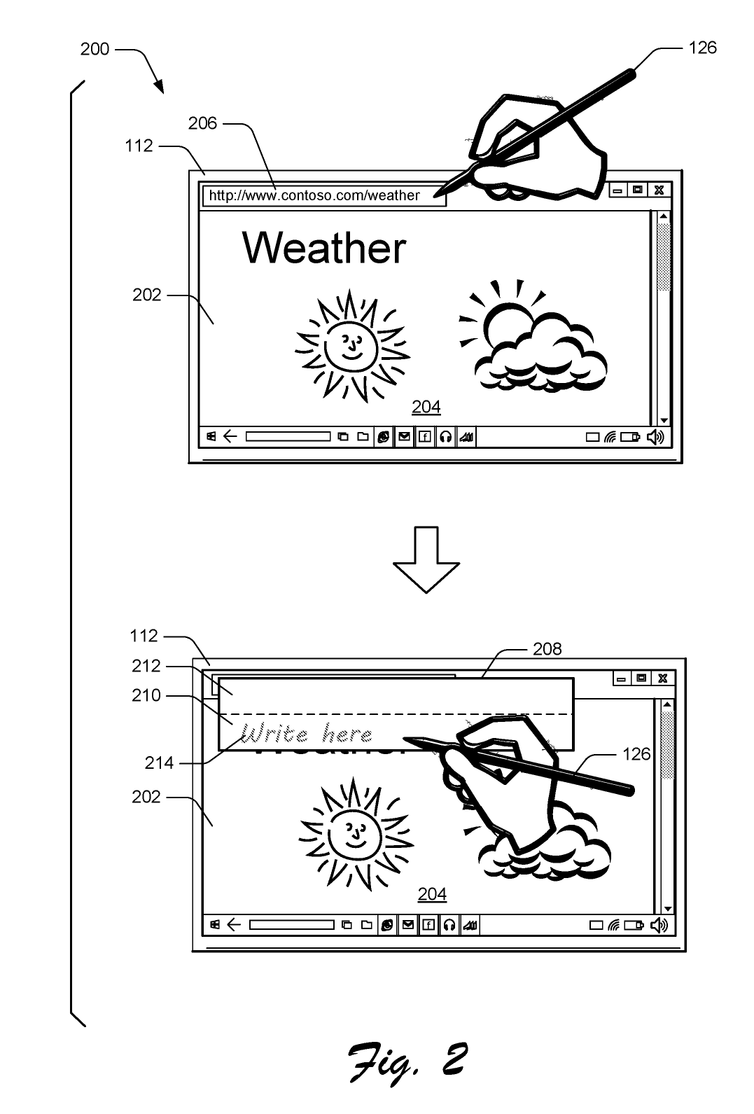

FIG. 2 depicts an example implementation scenario 200 for presenting an ink canvas in a web browser in accordance with one or more implementations. The upper portion of the scenario 200 includes a browser graphical user interface (GUI) 202 displayed on the display device 112. Generally, the GUI 202 represents a GUI for the web browser 110. Also depicted is a user holding the pen 126. Displayed within the GUI 202 is a web page 204 and an address bar 206. As shown, the address bar 206 includes a web address (e.g., a Uniform Resource Locator (URL)) for the web page 204. The user performs a proximity event inside or adjacent to the address bar 206 using the pen 126. For instance, the user taps inside and/or adjacent to the address bar 206 with the pen 126. Alternatively, the user brings the pen 126 in proximity to the surface of the display device 112 and within the GUI 202. The pen 126, for instance, is placed within a particular distance of the display device 112 (e.g., less than 2 centimeters) but not in contact with the display device 112. This behavior is generally referred to herein as “hovering” the pen 126.

Proceeding to the lower portion of the scenario 200 and in response to detecting the proximity event of the pen 126, an ink canvas 208 is presented within the GUI 202 and overlaying or replacing the address bar 206. Generally, the ink canvas 208 represents a visual affordance that indicates that ink functionality is active such that a user may apply ink within the ink canvas 208. For instance, the ink canvas includes an input region 210 and a recognition region 212. The input region 210 represents a portion of the ink canvas 208 that is configured to receive ink input, and the recognition region 212 represents a portion of the ink canvas 208 that is configured to output recognition results and suggestions from text recognition performed on input to the input region 210. In this particular example, the input region 210 includes an input prompt 214 that cues the user that the input region 210 is designated from receiving ink input.

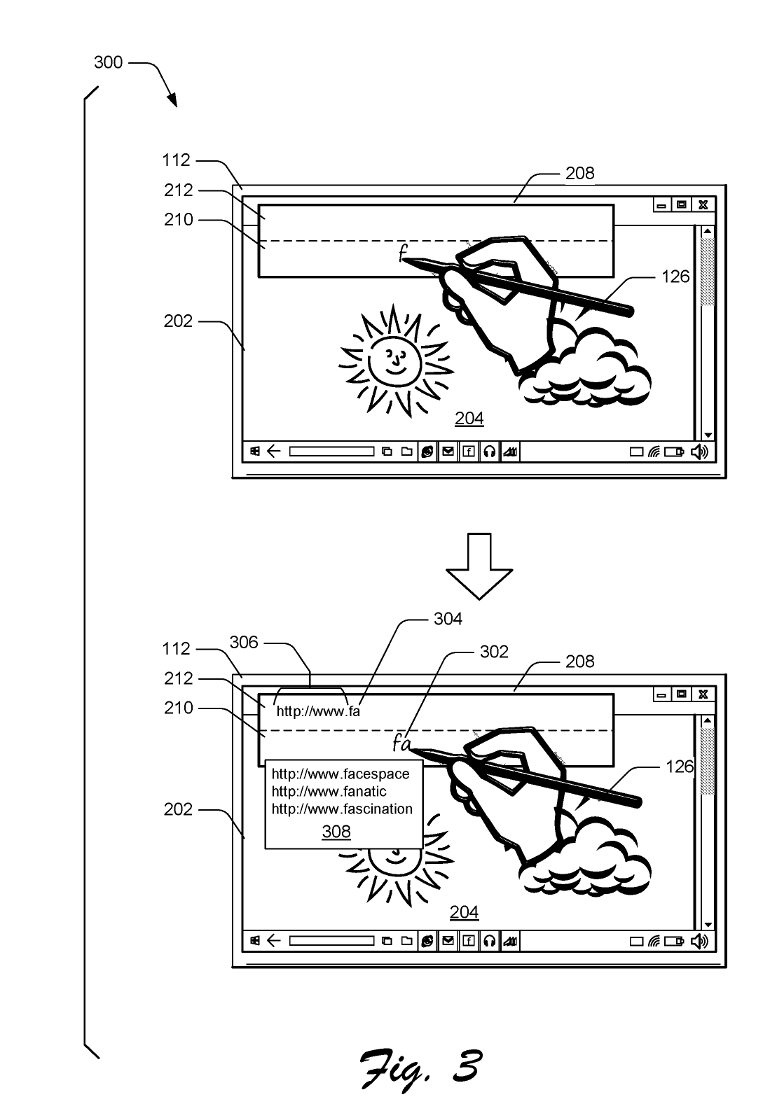

FIG. 3 depicts an example implementation scenario 300 for receiving input to an ink canvas in a web browser in accordance with one or more implementations. The scenario 300, for example, represents an extension of the scenario 200. The upper portion of the scenario 300 includes the GUI 202 displayed on the display device 112. Further shown is that the user begins writing (“applying ink”) with the pen 126 within the input region 210 of the ink canvas 208.

Proceeding to the lower portion of the scenario 300 and in response to the user input to the input region 210, the ink module 118 performs text recognition on input 302 and begins populating the recognition region 212 with text 304 recognized from the input 302. In this particular example, the recognition region 212 is automatically populated with a pre-formatted address prefix 306, e.g., “http://www.” since the context of the input is within a web browser and this is a likely intended prefix for a valid web address. In at least some implementations, a user may delete and/or edit the automatic prefix 306, such as by tapping on the prefix 306 with the pen 126 and/or other type of input. In this particular scenario, the text 304 is appended to the prefix 306.

Further shown are different completion suggestions 308 that are based on the text 304. The suggestions 308, for instance, include the text 304 and correspond to different web addresses that include the text 304. The suggestions 308 may be determined in various ways, such as based on past browsing history of a user, most popular web addresses, trending web searches, and so forth. According to various implementations, the user may tap the pen 126 over one of the addresses listed in the suggestions 308, which will cause the selected address to be automatically populated to the recognition region 212, and the web browser 110 to be navigated to an address associated with the selected suggestion. For instance, the web page 204 currently populated to the GUI 202 will be replaced with a web page from the selected address.

In at least some implementations, various criteria can be considered for visual placement of the suggestions 308 within the GUI 202. For instance, a user can specify where the suggestions 308 are to be presented, such as positionally in relation to the ink canvas 208. The web browser 110, for instance, includes a configurable setting that enables a user to specify where completion suggestions are to be presented. Consider, for example, that in the scenario 300 the user specifies that the suggestions 308 are to be presented at the lower left edge of the ink canvas 208. Accordingly, when the user enters the input 302, the suggestions 308 are presented at the lower left edge of the ink canvas 208 as depicted in the scenario 300.

Alternatively or additionally to being user configurable, placement of the suggestions 308 can be determined dynamically based on various detected conditions. For instance, the ink module 118 can detect an angle of the pen 126 relative to the display 112 and determine where to present the suggestions 308 based on the angle. Angle of the pen 126 may be determined in various ways, such as via proximity detection of various portions of the pen 126 relative to the surface of the display 112. With reference to the scenario 300, for example, consider that the ink module 118 ascertains that the pen 126 is angled rightward relative to the input 302. Accordingly, the ink module 118 causes the suggestions 308 to be presented to the left of the input 302 to prevent the suggestions 308 from being visually obscured by the pen 126 and/or the user's hand grasping the pen 126.

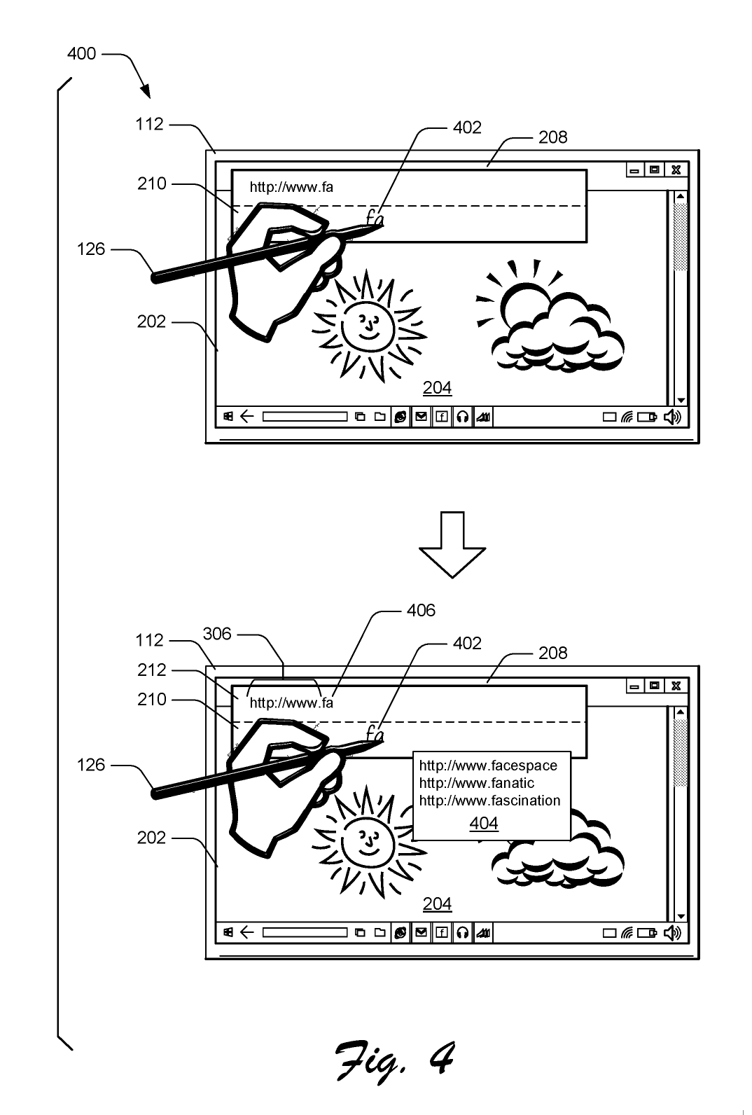

FIG. 4 depicts an example implementation scenario 400 for receiving input to an ink canvas in a web browser in accordance with one or more implementations. The scenario 400, for example, represents an extension of and/or variation on the scenarios 200, 300 discussed above. The upper portion of the scenario 300 includes the GUI 202 displayed on the display device 112. Further shown is that a user begins writing with the pen 126 within the input region 210 of the ink canvas 208 to apply input 402.

Proceeding to the lower portion of the scenario 400 and in response to the user input 402 to the input region 210, the ink module 118 performs text recognition on the input 402 and presents completion suggestions 404 that are based on the input 402. The suggestions 404, for instance, include characters 406 recognized from the input 402 as well as additionally, automatically generated characters. Generally, the suggestions 404 correspond to different web addresses that include the characters 406.

Notice in this particular scenario that the suggestions 404 are presented at the lower right edge of the ink canvas 208, in contrast with the position of the suggestions 308 depicted in the scenario 300. As mentioned above, a position where completion suggestions are presented can be determined based on various criteria, such as a default setting for the ink module 118, a user configured setting, dynamic logic that considers one or more state conditions pertaining to user interaction with the ink canvas 208, and so forth.

For instance, consider that the user in the scenario 400 is left-handed, and thus configures a setting of the web browser 110 to account for left-handed input from the pen 126. Accordingly, the ink module 118 causes the suggestions 404 to be presented rightward of the input 402 to prevent the suggestions 404 from being obscured by the user's left hand.

In an additional or alternative implementation, the ink module 118 determines an angle of the pen 126 relative to the input 402 and places the suggestions 404 at a position to avoid being obscured by the pen 126 and/or the user's hand grasping the pen 126. In yet another alternative or additional implementation, the ink module 118 determines a position of the user's hand relative to the display 112 (e.g., via capacitive and/or other detection technique) and places the suggestions 404 within the GUI 202 away from the user's hand to avoid being obscured by the hand.

Thus, the scenarios 300, 400 illustrate that completion suggestions based on ink input can be presented, and that locations for presentation of completion suggestions can be determined based on various criteria.

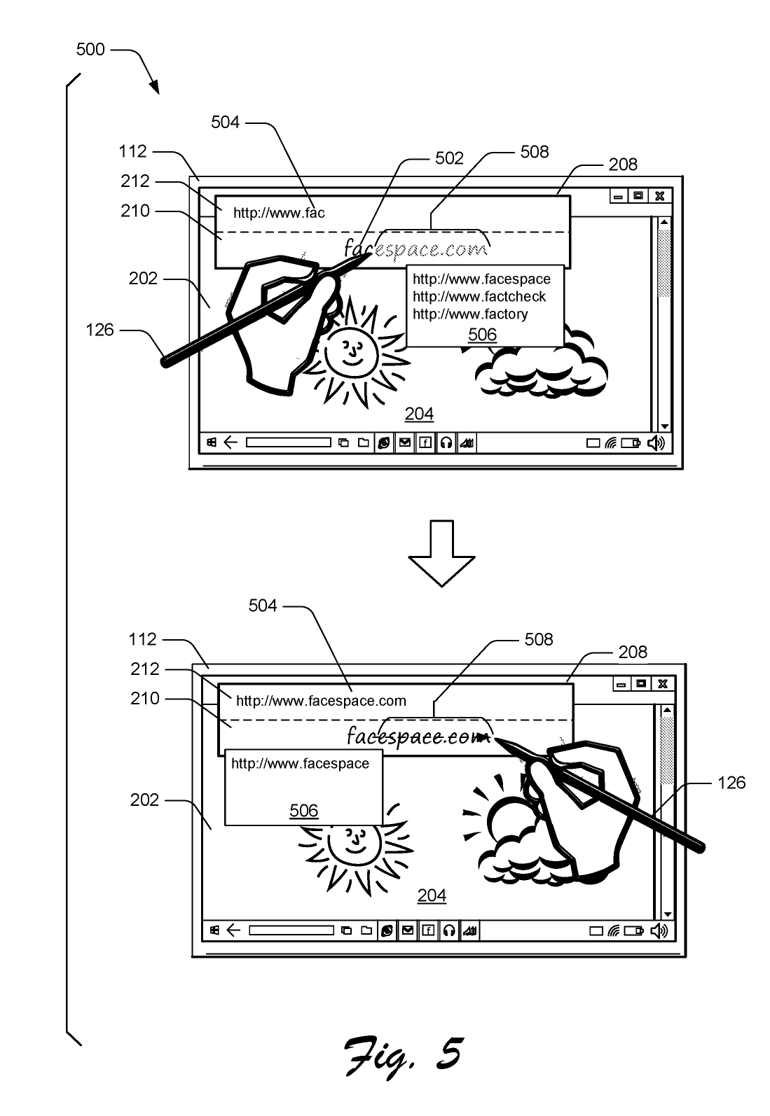

FIG. 5 depicts an example implementation scenario 500 for providing completion suggestions in accordance with one or more implementations. The scenario 500, for example, represents an extension and/or variation of the scenarios 200-400. The upper portion of the scenario 500 includes the GUI 202 with the website 204 displayed on the display device 112. Further shown is the user writing input 502 in the input region 210, recognition results 504 displayed in the recognition region 212, and completion suggestions 506 from the recognition results 504. Also shown is that as the user provides the input 502, an ink suggestion 508 is appended to the input 502. The ink suggestion 508, for instance, corresponds to a top suggestion from the recognition suggestions 506 and is automatically appended to the input 502 by the ink module 118 and independent of user input to input the ink suggestion 508. As shown, the ink suggestion 508 includes individual characters, such as letters, numbers, and/or other characters.

According to implementations discussed herein, the ink suggestion 508 may be generated in various ways. For instance, optical character recognition and pattern recognition can be performed on the input 502 to identify a font that most closely matches the characters of the input 502, i.e., the user's handwriting style used to provide the input 502. The identified font is then used to present the characters of the ink suggestion 508. In at least some implementations, characters of the input 502 may be reformatted with corresponding characters in the identified font.

The ink suggestion 508 may be presented in a different shading and/or color than the input 502, such as to enable a user to distinguish between the input 502 and the ink suggestion 508. For instance, shading of the ink suggestion 508 may be lighter than that of the input 502, such as to presented a “ghost” text appearance for the ink suggestion 508. Alternatively or additionally, the ink suggestion 508 may be presented in a different color than the input 502.

Further to techniques for ink input for browser navigation described herein, a user may interact with the ink suggestion 508 in various ways. For instance, the ink suggestion 508 is selectable to select the entire ink suggestion 508 and to cause a corresponding navigation to a website identified by the ink suggestion 508. Alternatively or additionally, individual letters of the ink suggestion 508 are individually selectable to select in individual letters without selecting the entire ink suggestion 508. For instance, consider that the user manipulates the pen 126 to trace and/or tap on the first two letters of the ink suggestion 508, i.e., “e” and “s.” In such a scenario, the letters would be added to the recognition results 504 displayed in the recognition region 212, and the recognition suggestions 506 would be updated to include suggestions that started with the letters “faces.”

In at least some implementations, character recognition performed on input to the input region 210 is performed based on an input device used to provide the input. For instance, the scenario 500 depicts a user providing the input 502 in standard English alphabetic characters. However, in addition to standard alphabetic characters, the pen 126 can be used to provide symbolic input in the form of shorthand and/or other abbreviated symbolic writing method. The symbolic input is then converted (e.g., by the ink module 118 and/or the input module 114) logically into text (e.g., American Standard Code for Information Interchange (ASCII) text) which is used to generate suggested navigation destinations, such as for the completion suggestions 308, 506, and/or the ink suggestion 508.

Continuing to the lower portion of the scenario 500, the user selects the ink suggestion 508, such as by dragging the pen 126 across the ink suggestion 508. Accordingly, the entire ink suggestion 508 is added to the recognition results 504 and a corresponding navigation to a network address identified by the indicated address is initiated. Consider, for instance, the following scenario.

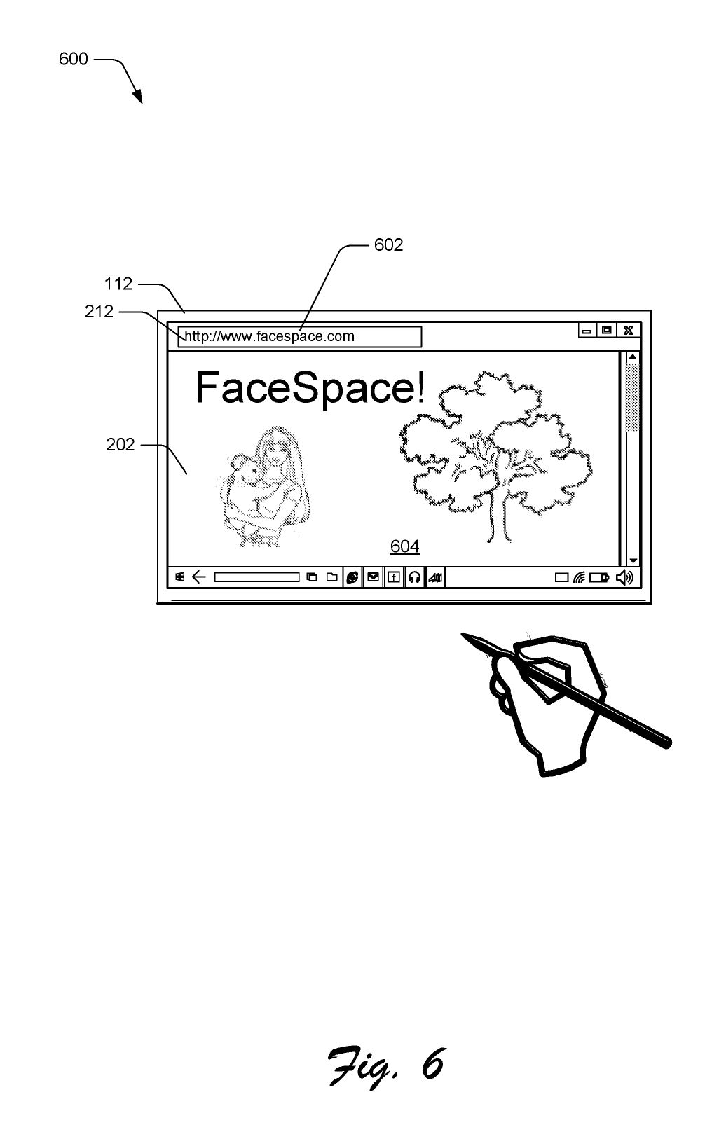

FIG. 6 depicts an example implementation scenario 600 for navigating to a website based on an address input via ink input in accordance with one or more implementations. The scenario 600, for example, represents a continuation of the scenario 500.

In the scenario 600, and responsive to user selection of the ink suggestion 508 described above, the ink canvas 208 is removed (“torn down”) and the web browser 110 is navigated to a web address 602 that corresponds to the ink suggestion 508 such that the web page 204 is replaced with a web page 604 in the GUI 202 displayed on the display device 112. The web page 604, for instance, represents a website found at the web address 602. Further, the address bar 206 is displayed with a web address 602.

While implementations are discussed herein with respect to touch input using the pen 126, it is to be appreciated that techniques for ink input for browser navigation may be implemented using any suitable touch and/or touchless input technique. For instance, other touch input devices 122 may be employed, such as a user's finger, a stylus, and so forth. Alternatively or additionally, touchless input techniques may be employed, such as within a mixed/virtual reality setting implemented using a mixed reality headset or other way of presenting an augmented reality and/or virtual reality user interface. For instance, the various visuals displayed in the scenarios described above may be displayed as part of a mixed/virtual reality setting, and user input via gestures may be detected in such a setting to enable the functionalities described herein. For instance, hand and finger gestures may be employed to provide ink input into a web browser interface.

Accordingly, techniques for ink input for browser navigation enable web browser with integrated ink logic that provides a seamless ink input experience for web browser navigation.

Having described some example implementation scenarios, consider now some example procedures for projection via a device in accordance with one or more implementations.

Example Procedures

The following discussion describes some example procedures for ink input for browser navigation in accordance with one or more embodiments. The example procedures may be employed in the environment 100 of FIG. 1, the system 1100 of FIG. 11, and/or any other suitable environment. The procedures, for instance, represent procedures for implementing the example implementation scenarios discussed above. In at least some embodiments, the steps described for the various procedures can be implemented automatically and independent of user interaction. The procedures may be performed locally at the client device 102, by the ink service 128, and/or via interaction between the client device 102 and the ink service 128. This is not intended to be limiting, however, and aspects of the methods may be performed by any suitable entity.

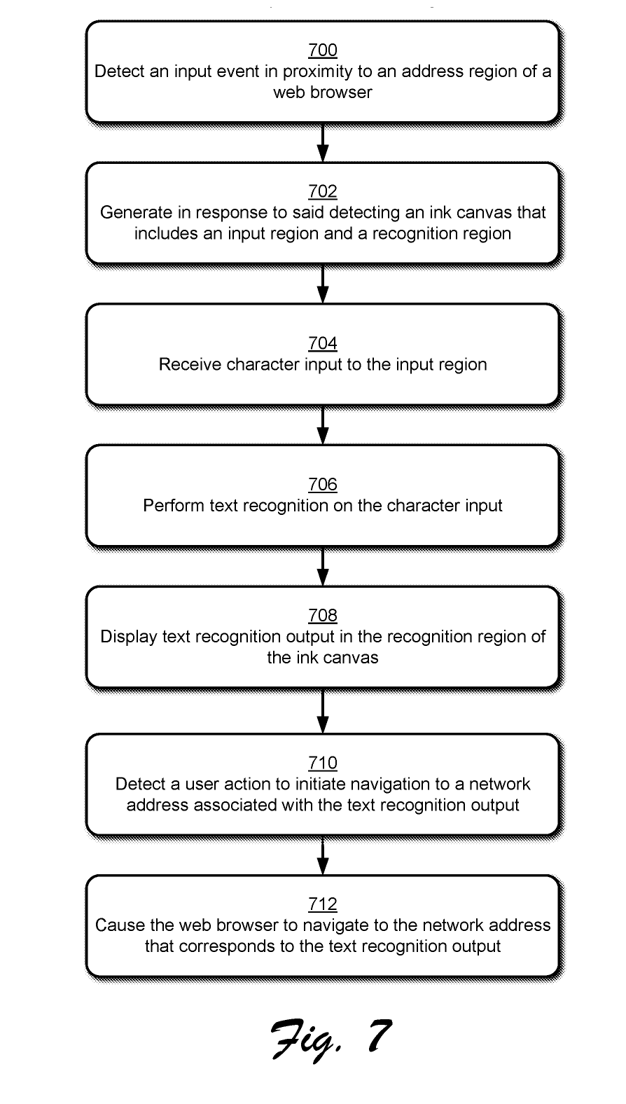

FIG. 7 is a flow diagram that describes steps in a method in accordance with one or more embodiments. The method describes an example procedure for presenting an ink canvas for a web browser in accordance with one or more implementations.

Step 700 detects an input event in proximity to an address region of a web browser. The ink module 118, for instance, detects an input event in proximity to the address bar 206 of the web browser 110. Various types of input events can be utilized, such as a pen or finger in contact with the display 112, a pen or finger hovered in proximity to the display 112, a touchless gesture detected in proximity to a virtual reality representation of the address bar 206, and so forth.

Step 702 generates in response to said detecting an ink canvas that includes an input region and a recognition region. The input region, for instance, is configured to receive freehand input, such as via a pen, a finger, a touchless gesture, and so forth. Further, the recognition region is configured to display text recognition output from text recognition performed on the freehand input to the input region.

The ink canvas can be displayed in various ways, such as partially or completely overlaying the address region, replacing the address region, and so forth.

Step 704 receives character input to the input region. The input may be provided in various ways, such as touch input using a pen or a finger, touchless input detected in proximity to the display 112, touchless gestures detected by a camera or other sensing functionality, and so forth. In at least some implementations, the character input represents freehand input of alphabetic, numeric, and/or symbolic characters.

Step 706 performs text recognition on the character input. Different types of text recognition may be employed, such as optical character recognition, character pattern recognition, and so forth. The text recognition, for instance, correlates characters of the input to known alphabetic, numeric, and/or symbolic characters (“known characters”), such as ASCII characters.

Step 708 displays text recognition output in the recognition region of the ink canvas. The text recognition output, for instance, represents known characters that are recognized from the character input to the input region.

Step 710 detects a user action to initiate navigation to a network address associated with the text recognition output. The text recognition output, for instance, represents a URL that corresponds to a website. A user may perform various actions to initiate navigation to the network address, such as selecting the text recognition output, removing the pen 126 from the display 112, performing a navigation-related gesture with the pen 126, and so forth.

Step 712 causes the web browser to navigate to the network address that corresponds to the text recognition output. The text recognition output, for instance, represents a web address (e.g., a URL) for a network location, such as a website. Thus, the web browser is navigated to the network location responsive to the user action to initiate navigation.

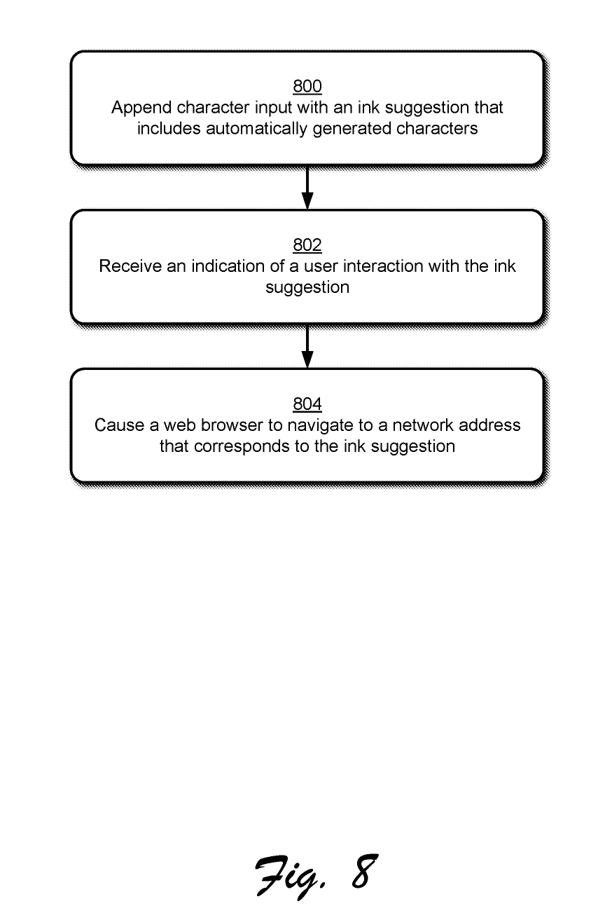

FIG. 8 is a flow diagram that describes steps in a method in accordance with one or more embodiments. The method describes an example procedure for presenting an ink suggestion based on character input in accordance with one or more implementations. The method, for instance, represents a variation on the method described above with reference to FIG. 7.

Step 800 appends character input with an ink suggestion that includes automatically generated characters. The character input, for instance, represents freehand input provided to the input region 210 of the ink canvas 208, such as described above. Generally, the ink suggestion represents a network address for a network location, such as a URL for a website. Further, the ink suggestion is generated via recognition of characters included as part of the character input, such as described above. In at least some implementations, the characters of the ink suggestion visually simulate a pattern of the one or more freehand characters and are visually distinguished from the character input, such as by shading and/or coloring the ink suggestion differently than the character input.

According to various implementations, the ink suggestion is dynamically updatable. For instance, when a user provides further character input after an ink suggestion is presented, the ink suggestion is dynamically changed to incorporate the further character input.

Step 802 receives an indication of a user interaction with the ink suggestion. The ink module 118, for instance, detects a user selection of the ink suggestion. Different types of user selection are recognizable, such as a tap on the ink suggestion, a drag gesture across the ink suggestion, a touchless gesture in proximity to the ink suggestion, selection of individual characters of the ink suggestion, and so forth.

Step 804 causes a web browser to navigate to a network address that corresponds to the ink suggestion. The web browser 110, for instance, navigates to a website identified by an address that corresponds to the ink suggestion.

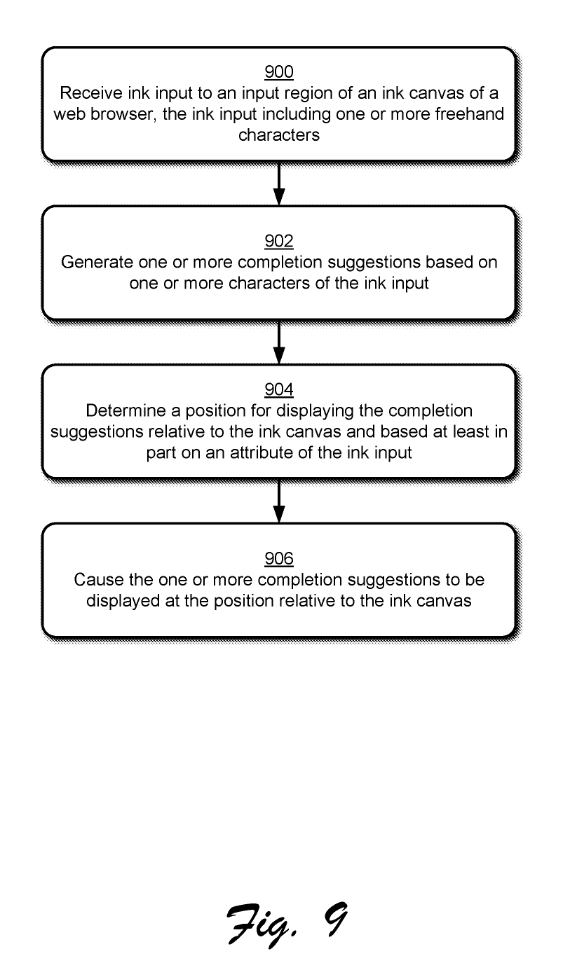

FIG. 9 is a flow diagram that describes steps in a method in accordance with one or more embodiments. The method describes an example procedure for presenting a completion suggestion based on character input in accordance with one or more implementations. The method, for instance, represents a variation on the methods described above with reference to FIGS. 7 and 8.

Step 900 receives ink input to an input region of an ink canvas of a web browser, the ink input including one or more freehand characters. Different ways of receiving ink input are described above, such as via a pen, a finger, a touchless gesture, and so forth. The ink input generally includes one or more characters that are recognizable as known characters.

Step 902 generates one or more completion suggestions based on one or more characters of the ink input. The completion suggestions, for instance, represent different network addresses that include characters recognized from the ink input. As mentioned above, completion suggestions may be determined in various ways, such as such as based on browsing history of a user, popular websites, trending web searches, and so forth. The ink module 118, for instance, may interface with the ink service 128 to retrieve completion suggestions. For example, text recognized from characters of the ink input can be submitted to a search engine and/or other web indexing functionality, which can return top search results that include the recognized text.

Step 904 determines a position for displaying the completion suggestions relative to the ink canvas and based at least in part on an attribute of the ink input. Generally, different attributes of ink input can be considered. For instance, a user setting can specify where completion suggestions are to be presented. Additionally or alternatively, a position of an input device (e.g., a pen, a finger, and so forth) can be detected, and a position for displaying the completion suggestions can be determined to avoid being obscured by the input device. Additionally or alternatively, a position of a user's hand relative to a display region can be detected, and a position for displaying the completion suggestions can be determined to avoid being obscured by the user's hand.

Step 906 causes the one or more completion suggestions to be displayed at the position relative to the ink canvas. The completion suggestions, for instance, are displayed adjacent the ink canvas and at the determined position. According to various implementations, a particular completion suggestion is selectable to cause a browser navigation to a network address identified by the completion suggestion.

In at least some implementations, positioning of completion suggestions is dynamically updatable. For instance, consider that a user provides ink input to the ink canvas 208 when their hand is at a first position on the display 112. Accordingly, completion suggestions can be presented based on the first position. However, if the user then moves their hand to a second, different position on the display 112, a position for presenting completion suggestions can be dynamically reconfigured to a different position. Accordingly, the completion suggestions can be moved to the different position to avoid being obscured by the user's hand.

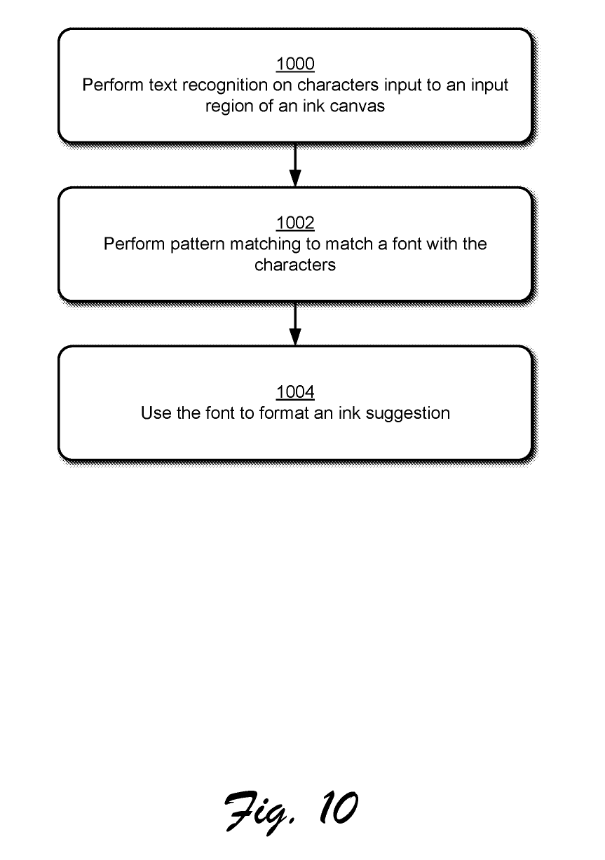

FIG. 10 is a flow diagram that describes steps in a method in accordance with one or more embodiments. The method describes an example procedure for formatting characters for an ink suggestion in accordance with one or more implementations. The method, for instance, represents an example way of performing step 800 of FIG. 8, discussed above.

Step 1000 performs text recognition on characters input to an input region of an ink canvas. The ink module 118 and/or the input module 114, for instance, perform pattern recognition on freehand input provided to the input region 210 of the ink canvas 208. Generally, the text recognition identifies known characters that correspond to the characters input to the input region.

Step 1002 performs pattern matching to match a font with the characters. For instance, a font that most closely visually matches a writing pattern of the characters is identified.

Step 1004 uses the font to format an ink suggestion. For instance, characters of an ink suggestion are generated using the font. In at least some implementations, the characters input to the ink canvas are replaced with corresponding characters in the identified font.

Having described some example procedures for ink input for browser navigation, consider now a discussion of an example system and device in accordance with one or more embodiments.

Example System and Device

FIG. 11 illustrates an example system generally at 1100 that includes an example computing device 1102 that is representative of one or more computing systems and/or devices that may implement various techniques described herein. For example, the client device 102 discussed above with reference to FIG. 1 can be embodied as the computing device 1102. The computing device 1102 may be, for example, a server of a service provider, a device associated with the client (e.g., a client device), an on-chip system, and/or any other suitable computing device or computing system.

The example computing device 1102 as illustrated includes a processing system 1104, one or more computer-readable media 1106, and one or more Input/Output (I/O) Interfaces 1108 that are communicatively coupled, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware element 1110 that may be configured as processors, functional blocks, and so forth. This may include implementation in hardware as an application specific integrated circuit or other logic device formed using one or more semiconductors. The hardware elements 1110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1106 is illustrated as including memory/storage 1112. The memory/storage 1112 represents memory/storage capacity associated with one or more computer-readable media. The memory/storage 1112 may include volatile media (such as random access memory (RAM)) and/or nonvolatile media (such as read only memory (ROM), Flash memory, optical disks, magnetic disks, and so forth). The memory/storage 1112 may include fixed media (e.g., RAM, ROM, a fixed hard drive, and so on) as well as removable media (e.g., Flash memory, a removable hard drive, an optical disc, and so forth). The computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “entity,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1102. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 1110 and computer-readable media 1106 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of modules that are executable by the computing device 1102 as software may be achieved at least partially in hardware, e.g., through use of computer-readable storage media and/or hardware elements 1110 of the processing system. The instructions and/or functions may be executable/operable by one or more articles of manufacture (for example, one or more computing devices 1102 and/or processing systems 1104) to implement techniques, modules, and examples described herein.

As further illustrated in FIG. 11, the example system 1100 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1100, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1102 may assume a variety of different configurations, such as for computer 1114, mobile 1116, and television 1118 uses. Each of these configurations includes devices that may have generally different constructs and capabilities, and thus the computing device 1102 may be configured according to one or more of the different device classes. For instance, the computing device 1102 may be implemented as the computer 1114 class of a device that includes a personal computer, desktop computer, a multi-screen computer, laptop computer, netbook, and so on.

The computing device 1102 may also be implemented as the mobile 1116 class of device that includes mobile devices, such as a mobile phone, portable music player, portable gaming device, a tablet computer, a wearable device, a multi-screen computer, and so on. The computing device 1102 may also be implemented as the television 1118 class of device that includes devices having or connected to generally larger screens in casual viewing environments. These devices include televisions, set-top boxes, gaming consoles, and so on.

The techniques described herein may be supported by these various configurations of the computing device 1102 and are not limited to the specific examples of the techniques described herein. For example, functionalities discussed with reference to the client device 102, the ink module 118, and/or the ink service 128 may be implemented all or in part through use of a distributed system, such as over a “cloud” 1120 via a platform 1122 as described below.

The cloud 1120 includes and/or is representative of a platform 1122 for resources 1124. The platform 1122 abstracts underlying functionality of hardware (e.g., servers) and software resources of the cloud 1120. The resources 1124 may include applications and/or data that can be utilized while computer processing is executed on servers that are remote from the computing device 1102. Resources 1124 can also include services provided over the Internet and/or through a subscriber network, such as a cellular or Wi-Fi network.

The platform 1122 may abstract resources and functions to connect the computing device 1102 with other computing devices. The platform 1122 may also serve to abstract scaling of resources to provide a corresponding level of scale to encountered demand for the resources 1124 that are implemented via the platform 1122. Accordingly, in an interconnected device embodiment, implementation of functionality described herein may be distributed throughout the system 1100. For example, the functionality may be implemented in part on the computing device 1102 as well as via the platform 1122 that abstracts the functionality of the cloud 1120.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

Implementations discussed herein include:

### EXAMPLE 1

A system for providing a suggestion for navigating a web browser to a network location, the system including: a display; one or more processors; and one or more computer-readable storage media storing computer-executable instructions that, responsive to execution by the one or more processors, cause the system to perform operations including: detecting a pen in proximity to an address region of a web browser displayed on the display; generating in response to said detecting an ink canvas that includes an input region configured to receive ink input and a recognition region configured to display text recognition output from text recognition performed on ink input to the input region; receiving ink input to the input region, the ink input including one or more freehand characters; appending the ink input with an ink suggestion that includes one or more automatically generated characters that visually simulate a pattern of the one or more freehand characters, the automatically generated characters being distinguishable from the one or more freehand characters based on one or more of a shading or a color of the automatically generated characters; displaying text recognition output in the recognition region based on text recognition of the ink input; detecting a user action to initiate navigation to a network address associated with the text recognition output; and causing the web browser to navigate to the network address that corresponds to the ink suggestion.

### EXAMPLE 2

The system as described in example 1, wherein the ink canvas is displayed overlaying the address region.

### EXAMPLE 3

The system as described in one or more of examples 1 or 2, wherein the address region includes an address bar of the web browser, and the ink canvas is displayed overlaying or replacing the address bar.

### EXAMPLE 4

The system as described in one or more of examples 1-3, wherein the operations further include: performing pattern matching on the ink input to match a font with the freehand characters; and formatting the ink suggestion with the font.

### EXAMPLE 5

The system as described in one or more of examples 1-4, wherein the operations further include: performing pattern matching on the ink input to match a font with the freehand characters; and formatting the ink suggestion with the font and reformatting the freehand characters with the font.

### EXAMPLE 6

The system as described in one or more of examples 1-5, wherein said appending includes displaying the ink suggestion with one or more of a different shading or a different color than the ink input.

### EXAMPLE 7

The system as described in one or more of examples 1-6, wherein the operations further include: recognizing the ink input as one or more symbolic characters; converting the one or more symbolic characters into text; and performing text recognition on the text to generate the text recognition output.

### EXAMPLE 8

The system as described in one or more of examples 1-7, wherein the indication of the user interaction with the ink suggestion includes a user gesture across one or more characters of the ink suggestion.

### EXAMPLE 9

The system as described in one or more of examples 1-8, wherein the ink suggestion includes multiple characters, the indication of the user interaction with the ink suggestion includes a user selection of less than all characters of the ink suggestion, and wherein the operations further include adding the selected characters to the text recognition output in the recognition region.

### EXAMPLE 10

The system as described in one or more of examples 1-9, wherein the operations further include causing one or more completion suggestions for the ink input to be presented at a position that is determined based on a position of the pen relative to the display.

### EXAMPLE 11

A method for providing an ink canvas for a web browser, the method including: detecting an input event in proximity to an address region of a web browser displayed on a display; generating in response to said detecting an ink canvas that includes an input region configured to receive freehand input and a recognition region configured to display text recognition output from text recognition performed on freehand input to the input region; overlaying or replacing the address region with the ink canvas; receiving freehand character input to the input region; displaying text recognition output in the recognition region based on text recognition of the character input; and causing the web browser to navigate to a network address that corresponds to the text recognition output.

### EXAMPLE 12

The method as described in example 11, wherein the input event includes one of a pen in proximity to the address region, a finger in proximity to the address region, or a touchless gesture in proximity to the address region.

### EXAMPLE 13

The method as described in one or more of examples 11 or 12, further including receiving a user selection of the text recognition output in the recognition region, wherein said causing the web browser to navigate to the network address occurs in response to the user selection of the text recognition output.

### EXAMPLE 14

The method as described in one or more of examples 11-13, further including appending the character input to the input region with an ink suggestion that represents a web address that includes one or more characters of the character input.

### EXAMPLE 15

The method as described in one or more of examples 11-14, further including appending the character input to the input region with an ink suggestion that represents a web address that includes one of more characters of the character input, wherein the ink suggestion differs in one or more of shading or color from the character input.

### EXAMPLE 16

The method as described in one or more of examples 11-15, further including appending the character input to the input region with an ink suggestion that represents a web address that includes one of more characters of the character input, wherein the ink suggestion is presented in a font that is matched to a pattern of the character input.

### EXAMPLE 17

A method for determining a display position for completion suggestions in a web browser, the method including: receiving ink input to an input region of an ink canvas of a web browser, the ink input including one or more freehand characters; generating one or more completion suggestions based on one or more characters of the ink input; determining a position for displaying the completion suggestions relative to the ink canvas and based at least in part on an attribute of the ink input; and causing the one or more completion suggestions to be displayed at the position relative to the ink canvas.

### EXAMPLE 18

The method as described in example 17, wherein the attribute of the ink input includes a user-configured setting that specifies a position for the completion suggestions.

### EXAMPLE 19

The method as described in one or more of examples 17 or 18, wherein the attribute of the ink input includes a position of a user's hand on a display on which the ink canvas is displayed.

### EXAMPLE 20

The method as described in one or more of examples 17-19, wherein the attribute of the ink input includes an angle of an input device relative to a display on which the ink canvas is displayed.

Conclusion

Techniques for ink input for browser navigation are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A system comprising:
a display;
one or more processors; and
one or more computer-readable storage media storing computer-executable instructions that, responsive to execution by the one or more processors, cause the system to perform operations including:
detecting a pen in proximity to an address region of a web browser displayed on the display;
generating in response to said detecting an ink canvas that includes an input region configured to receive ink input and a recognition region configured to display text recognition output from text recognition performed on ink input to the input region;
receiving ink input to the input region, the ink input including one or more freehand characters;
appending the ink input with an ink suggestion that includes one or more automatically generated characters that visually simulate a pattern of the one or more freehand characters, the automatically generated characters being distinguishable from the one or more freehand characters based on one or more of a shading or a color of the automatically generated characters;
displaying text recognition output in the recognition region based on text recognition of the ink input;
detecting a user action to initiate navigation to a network address associated with the text recognition output; and
causing the web browser to navigate to a network address that corresponds to the ink suggestion.

2. The system as described in claim 1, wherein the ink canvas is displayed overlaying the address region.

3. The system as described in claim 1, wherein the address region comprises an address bar of the web browser, and the ink canvas is displayed overlaying or replacing the address bar.

4. The system as described in claim 1, wherein the operations further include:
performing pattern matching on the ink input to match a font with the freehand characters; and
formatting the ink suggestion with the font.

5. The system as described in claim 1, wherein the operations further include:
performing pattern matching on the ink input to match a font with the freehand characters; and
formatting the ink suggestion with the font and reformatting the freehand characters with the font.

6. The system as described in claim 1, wherein said appending comprises displaying the ink suggestion with one or more of a different shading or a different color than the ink input.

7. The system as described in claim 1, wherein the operations further include:
recognizing the ink input as one or more symbolic characters;
converting the one or more symbolic characters into text; and
performing text recognition on the text to generate the text recognition output.

8. The system as described in claim 1, wherein the indication of the user interaction with the ink suggestion comprises a user gesture across one or more characters of the ink suggestion.

9. The system as described in claim 1, wherein the ink suggestion includes multiple characters, the indication of the user interaction with the ink suggestion comprises a user selection of less than all characters of the ink suggestion, and wherein the operations further include adding the selected characters to the text recognition output in the recognition region.

10. The system as described in claim 1, wherein the operations further include causing one or more completion suggestions for the ink input to be presented at a position that is determined based on a position of the pen relative to the display.

11. A method comprising:
detecting an input event in proximity to an address region of a web browser displayed on a display;
generating in response to said detecting an ink canvas that includes an input region configured to receive freehand input and a recognition region configured to display text recognition output from text recognition performed on freehand input to the input region;
overlaying or replacing the address region with the ink canvas;
receiving freehand character input to the input region;
displaying text recognition output in the recognition region based on text recognition of the character input; and
causing the web browser to navigate to a network address that corresponds to the text recognition output.

12. The method as recited in claim 11, wherein the input event comprises one of a pen in proximity to the address region, a finger in proximity to the address region, or a touchless gesture in proximity to the address region.

13. The method as recited in claim 11, further comprising receiving a user selection of the text recognition output in the recognition region, wherein said causing the web browser to navigate to the network address occurs in response to the user selection of the text recognition output.

14. The method as recited in claim 11, further comprising appending the character input to the input region with an ink suggestion that represents a web address that includes one or more characters of the character input.

15. The method as recited in claim 11, further comprising appending the character input to the input region with an ink suggestion that represents a web address that includes one of more characters of the character input, wherein the ink suggestion differs in one or more of shading or color from the character input.

16. The method as recited in claim 11, further comprising appending the character input to the input region with an ink suggestion that represents a web address that includes one of more characters of the character input, wherein the ink suggestion is presented in a font that is matched to a pattern of the character input.

17. A method comprising:
receiving ink input to an input region of an ink canvas of a web browser, the ink input including one or more freehand characters;
generating one or more completion suggestions based on one or more characters of the ink input;
determining a position for displaying the completion suggestions relative to the ink canvas and based at least in part on an attribute of the ink input; and
causing the one or more completion suggestions to be displayed at the position relative to the ink canvas.

18. The method as recited in claim 17, wherein the attribute of the ink input comprises a user-configured setting that specifies a position for the completion suggestions.

19. The method as recited in claim 17, wherein the attribute of the ink input comprises a position of a user's hand on a display on which the ink canvas is displayed.

20. The method as recited in claim 17, wherein the attribute of the ink input comprises an angle of an input device relative to a display on which the ink canvas is displayed.
